(19) United States
(12) Patent Application Publication
(10) Pub. No.: US 2004/0103767 A1
(43) Pub. Date: Jun. 3, 2004

(54) Method and mechanism for setting blind cutting size for blind cutting machine

(75) Inventors: Jung-Kuei Lin, Hsinchu (TW); Kuei-Lu Liu, Hsinchu (TW)

Correspondence Address: BACON & THOMAS, PLLC, 625 SLATERS LANE, FOURTH FLOOR, ALEXANDRIA, VA, 22314

(73) Assignees: INDUSTRIAL TECHNOLOGY RESEARCH INSTITUTE, HSINCHU (TW); NIEN MADE ENTERPRISE CO., LTD., TAICHUNG (TW)

(21) Appl. No.: 10/384,525

(22) Filed: Mar. 11, 2003

(30) Foreign Application Priority Data
Nov. 29, 2002 (TW) 91134712

(51) Int. Cl. B26D 1/00; B26D 3/00; B26D 5/20; B26D 7/27; B26D 7/28

(52) U.S. Cl. 83/13; 83/76.9; 83/522.19

(57) ABSTRACT

The present invention provides a blind cutting size setting mechanism and a blind cutting size setting method of the same for a blind cutting machine. The blind cutting size setting mechanism includes a base frame, a motor fixedly mounted on the base frame, a locating frame, the locating frame having an open frame body fixedly fastened to the base frame and a transmission screw rod fastened pivotally with the open frame body and coupled to the motor and two guide rods fixedly fastened to the open frame body, and a positioning control unit adapted to move in the locating frame between a start position and an end position upon operation of the motor to stop the blind to be cut in position for cutting, the positioning control unit having a screw hole and two through hole respectively coupled to the transmission screw rod and guide rod of the locating frame for enabling the positioning control unit to be moved along the guide rods upon rotary motion of the transmission screw rod.

### BACKGROUND OF THE INVENTION

1. Field of the Invention

The present invention relates generally to a blind cutting machine, and more specifically to a blind cutting size setting method and a blind cutting size setting mechanism for a blind cutting machine.

2. Description of the Related Art

Blind manufacturers provide few sizes (lengths of headrail, bottom rail and slats) for each model. Distributors or upholsterers may have to cut blinds purchased from factories to fit different windows to be covered with blinds. Conventionally, the headrail, bottom rail, and slats of a blank blind are separately cut. Various blind cutting machines have been disclosed, and have appeared on the market.

When using a blind cutting machine to cut a blank blind, the operator must adjust the position of a locating block for keeping an inserted blank blind in position for cutting a desired size for the blank blind, and then operate the blind cutting machine to move a selected cutter unit across the blank blind, thereby causing the selected cutter unit to cut the blank blind. When adjusting the position of the locating block, the operator needs to rotate a screw rod by hand, and to visually check the displacement of the locating block along a scale. Because visual errors tend to occur, it is difficult to control of positioning the locating block accurately. It also takes time and efforts to move the locating block to a desired location. Further, because calculating to cut the desired size must consider the mounting type of the blind, i.e., inside mount or outside mount. Different mounting types use different calculation formulas. It is not complicated to calculate to cut the desired size. In addition, a calculation error may be easily generated and results in loss of products.

### SUMMARY OF THE INVENTION

The present invention has been accomplished under the circumstances in view. It is the main object of the present invention to provide a blind cutting size setting method, which enables the user to control the blind cutting machine to set the blind to be cut in position for cutting subject to the desired size by means of inputting parameter data into the control unit of the blind cutting machine. It is another object of the present invention to provide a blind cutting machine, which includes a blind cutting size setting mechanism for running the application of the cutting size setting method.

To achieve the foregoing objects of the present invention, the blind cutting size setting mechanism includes a base frame, a motor fixedly mounted on the base frame, a locating frame, the locating frame having an open frame body fixedly fastened to the base frame and a transmission screw rod fastened pivotally with the open frame body and coupled to the motor and two guide rods fixedly fastened to the open frame body, and a positioning control unit adapted to move in the locating frame between a start position and an end position upon operation of the motor to stop the blind to be cut in position for cutting, the positioning control unit having a screw hole and two through hole respectively coupled to the transmission screw rod and guide rod of the locating frame for enabling the positioning control unit to be moved along the guide rods upon rotary motion of the transmission screw rod.

### BRIEF DESCRIPTION OF THE DRAWINGS

FIG. 1 is a schematic view of a preferred embodiment of the present invention.

FIG. 2 is a top view of the preferred embodiment of the present invention at work.

FIG. 3 is a. side view of a blind cutting size setting mechanism of the preferred embodiment of the present invention.

FIG. 4 is an elevational sectional view of the blind cutting size setting mechanism of the preferred embodiment of the present invention.

FIG. 5 is a block diagram showing the operation flow of the blind cutting size setting mechanism of the preferred embodiment of the present invention.

FIG. 6 is a schematic drawing showing the menu of inside mount window's width measurement in whole number on a human-machine interface according to the preferred embodiment of the present invention.

FIG. 7 is a schematic drawing showing the menu of inside mount window's width measurement in fraction on a human-machine interface according to the preferred embodiment of the present invention.

FIG. 8 is a schematic drawing showing an operation example of a conventional input interface according to the preferred embodiment of the present invention.

### DETAILED DESCRIPTION OF THE INVENTION

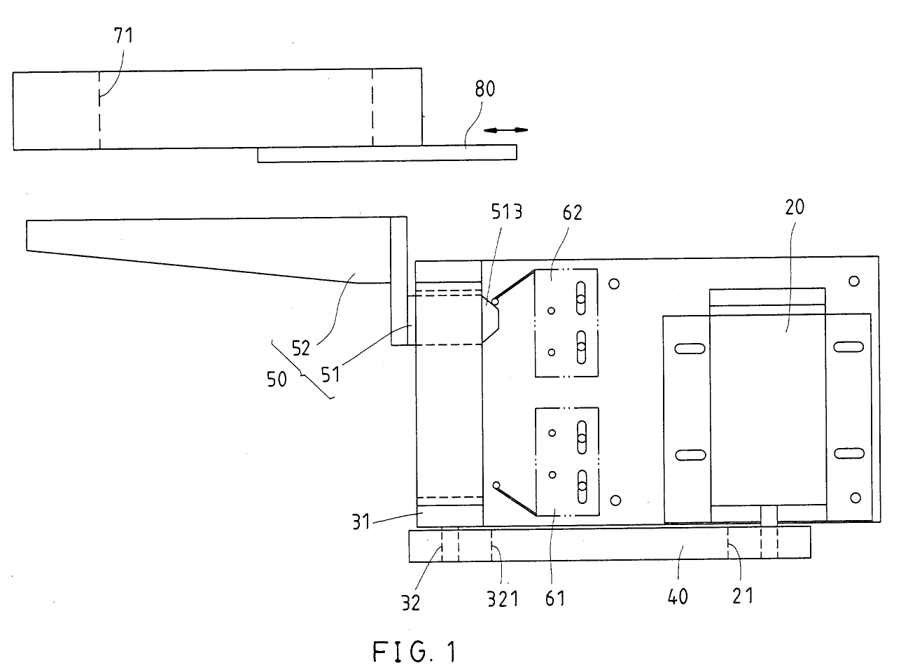

Referring to FIG. 1, a blind cutting machine is shown comprised of a machine base (not shown), which has at least one die cavity 71 through which a blind to be cut is inserted from the outside of the machine base to the inside of the machine base for cutting, at least one cutter unit 80 mounted in the machine base (not shown) and respectively controlled to reciprocate across an inner side of the die cavity 71 and to further cut the blind inserted into the die cavity 71, and a blind cutting size setting mechanism installed in the machine base (not shown) for setting the desired blind cutting size. The cutter unit 80 can be embodied as a saw-cut cutting unit or die-cut cutting unit, or a combination of the saw-cut cutting unit and the die-cut cutting unit.

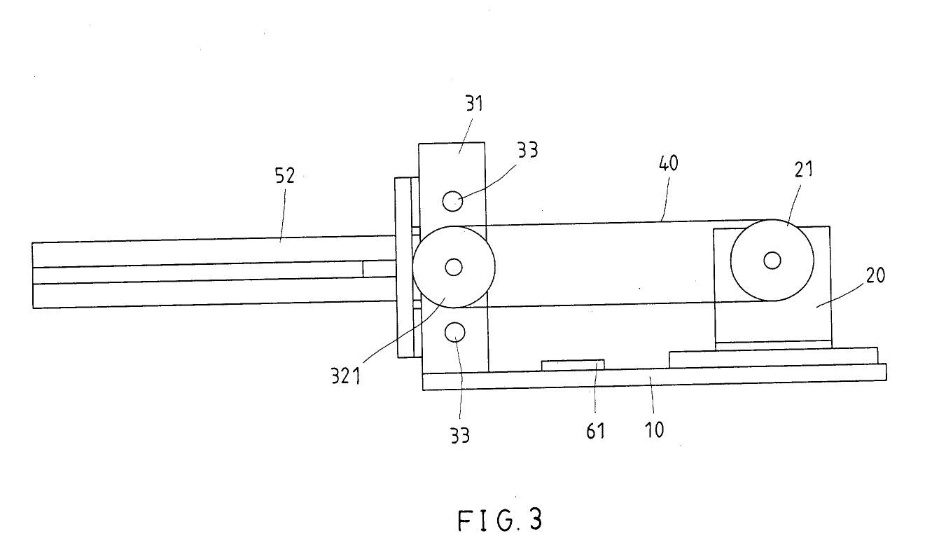

Referring to FIGS. 1-4, the blind cutting size setting mechanism is composed of a base frame 10, a one-way induction motor 20, a locating frame 30, a transmission device 40, a positioning control unit 50, and two micro switches 61 and 62.

The base frame 10 is embodied as a worktable on the machine base (not shown) of the blind cutting machine.

The one-way induction motor 20 is fixedly mounted on the base frame 10, including a signal feedback device (not shown) adapted to transmit a signal indicative of the revolving speed of the motor 20 to an external interface, and a driving wheel 21 fixedly mounted on an output shaft thereof and adapted to rotate synchronically therewith.

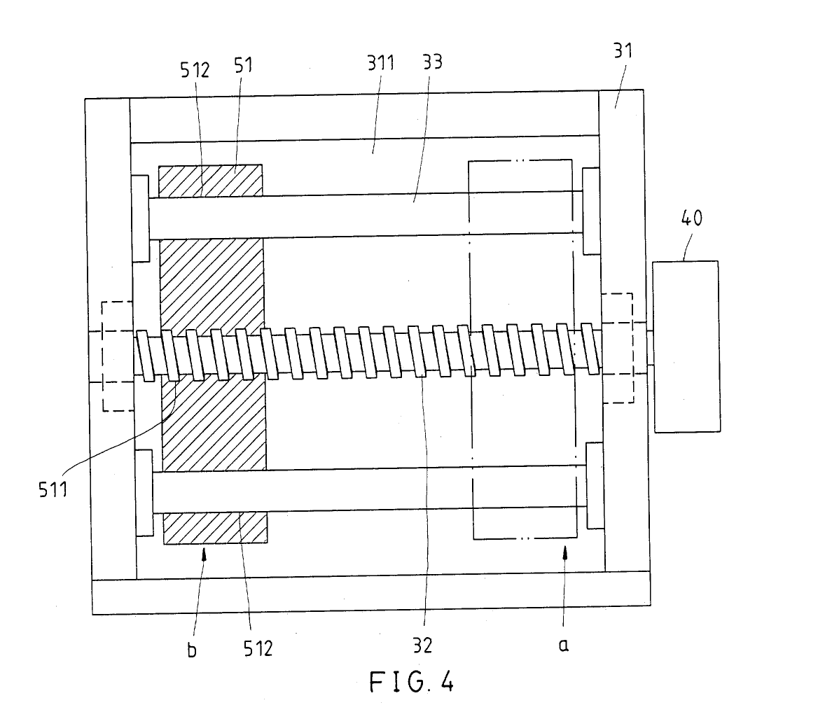

The locating frame 30 includes a rectangular open frame body 31 fastened to the base frame 10 vertically, defining a horizontally extended sliding space 311 (see FIG. 4), a transmission screw rod 32 rotatably mounted to the open frame body 31 within the sliding space 311 in a horizontal position and having an end extended out of the open frame body 31, a driven wheel 321 fixedly fastened to an end of the transmission screw rod 32 outside the open frame body 31 corresponding to the driving wheel 21 of the motor 20, and two guide rods 33 horizontally fastened to the open frame body 31 and being parallel to each other and located at respectively top and bottom sides of the transmission screw rod 32.

The transmission device 40 embodied as a transmission belt is fitted and connected on the two driving wheels 21 and 321 for transferring the rotary driving force of the motor 20 to the transmission rod 32.

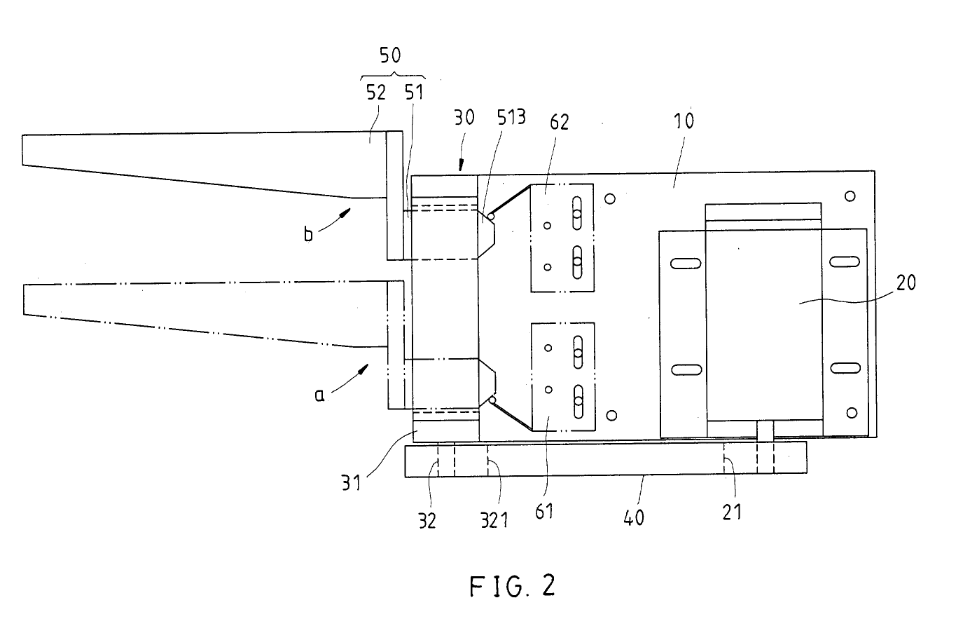

The positioning control unit 50 includes a slide 51 and a scale 52. The slide 51 has a screw hole 511 and two through holes 512 at two sides of the screw hole 511. The relative position and pitch between the screw hole 511 and the through holes 512 correspond to the relative position and pitch between the transmission rod 32 and the guide rods 33. The transmission screw rod 32 and the guide rods 33 are inserted respectively through the screw hole 511 and the through holes 512 respectively to support the slide 51 in the sliding space 311 of the open frame body 31, for enabling the slide 51 to be moved axially along the transmission screw rod 32 between a start position (a) and an end position (b) upon rotary motion of the transmission screw rod 32 (see FIG. 2). The guide rods 33 guide movement of the slide 51 in axial direction along the transmission screw rod 32, preventing the slide 51 from a radial displacement. The slide 51 has a protruded portion 513 extended from a bottom inner side thereof. The scale 52 is an elongated rectangular plate member, having an end fastened to an outer side of the slide 51.

The micro switches 61 and 62 are fixedly mounted on the base frame 10 at locations corresponding to the start position (a) and the end position (b), such that the protruded portion 513 of the slide 51 touches one micro switch 61 when the slide 51 is moved to the start position (a), or touches the other micro switch 62 when the slide 51 is moved to the end position (b) (see FIG. 2). When the protruded portion 513 of the slide 51 touches one of micro switches 61 and 62, the motor 20 will stop. Therefore, the slide 51 is controlled to move between the start position (a) and the end position (b).

Before the operation of the blind cutting machine, the motor 20 is electrically connected to a control unit (not shown) that controls the operation of the cutter unit(s) of the blind cutting machine, so that the control unit of the blind cutting machine can control the operation of the blind cutting size setting mechanism. According to this embodiment, the blind cutting machine provides a saw-cut cutting mode and a die-cut cutting mode.

Further, it is necessary to cut the both ends of the blind, so that the blind has a good balance and smooth ends after cutting. When calculating the size to be cut off, the control unit will divide the total size to be cut off by 2 to obtain the figure of the size to be cut off at each end of the blind.

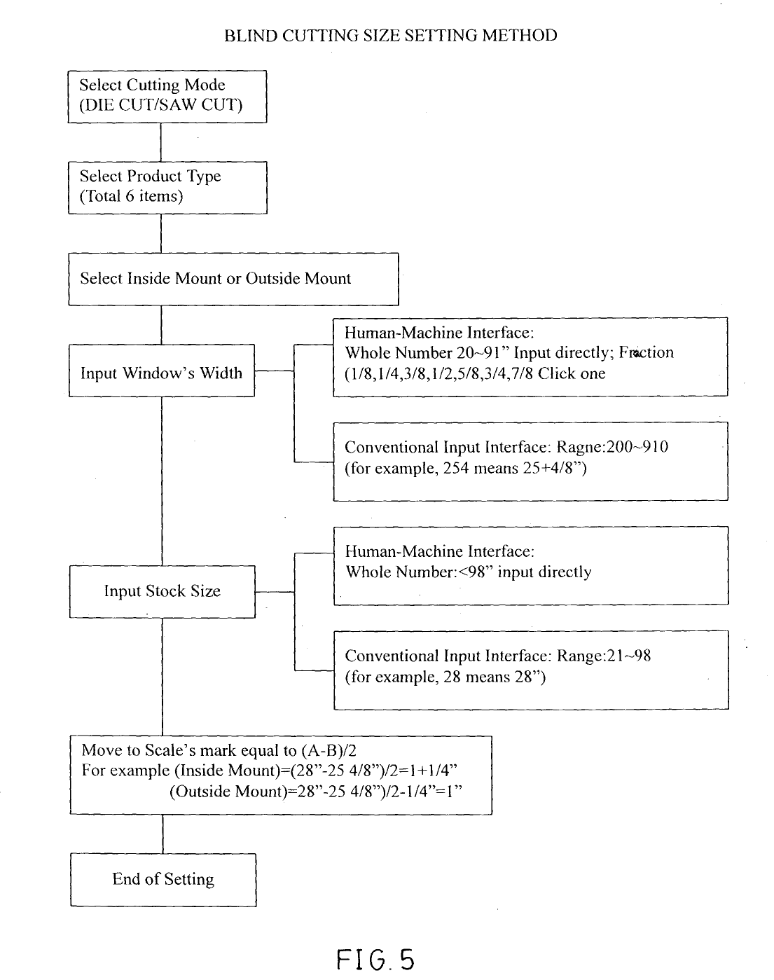

Referring to FIG. 5, the blind cutting size setting method includes following steps. At Step (a), input one of the operation modes. At Step (b), input window's width and stock size for enabling the control unit to calculate the size to be cut off subject to a predetermined operation formula. At Step (c), enable the control unit to move the blind cutting size setting mechanism to a predetermined position to stop the inserted blank blind in position for cutting subject to the size to be cut obtained. During Step (a), the operator selects the desired cutting mode (die-cut cutting mode or saw-cut cutting mode) from the control unit and then selects product type from the control unit (select type and material such as plastic, aluminum, wood, or headrail, bottom rail, etc.) so as to set the feed speed (die-cut cutting mode) or revolving speed (saw-cut cutting mode), and then selects blind mounting mode (inside mount or outside mount). During the aforesaid Step (b), the operator inputs the window's width measurement and then the stock size (the length measurement of the blank blind before cut) through the control unit, for enabling the control unit to calculate the size to be cut off Specifically, if the operator selects 25 4/8 inches for Window's Width (B) and 28 inches for Stock Size (A) at Sept (b) and selects inside mount for blind mounting mode at Step (a), the control unit will calculate: (A−B)/2=(28−25+4/8)/2=1+¼ inches. Because inside mount is selected, the size of the blind after cut will be same as the window's width measurement, enabling the blind to be installed inside the window. If the operator selects outside mount at Step (a) and the window's width measurement is same as the aforesaid example, the control unit will calculate: (A−B)/2−14=(28−25+4/8)/2−¼=1 inch and show the calculation result on the display screen. Because outside mount is selected, the control unit will deduct ¼ inch from the size to be cut off at each end of the blind so that the size of the blind can be 2/4 (½) inch longer than the window's width measurement, enabling the blind to be installed outside the window. During the aforesaid Step (c), the control unit controls the motor 20 to rotate the driving wheel 21 at an amount corresponding to the size to be cut off, causing the driving wheel 21 to rotate the transmission device 40, the driven wheel 321 and the transmission rod 32 so as to further move the slide 51 and the scale 52 from the start position (a) toward the end position (b). During rotary motion of the motor 20, a feedback signal is transmitted from the motor 20 to the control unit. When the feedback signal conforms to the calculated date of the size to be cut off, the control unit stops the motor 20. At the same time, an end of the blank blind is stopped against the scale 52, and the distance between the scale 52 and the selected cutter unit 80 is equal to the size to be cut off at one single end of the blank blind. After cutting off the end of the blank blind by the cutter unit 80, the blank blind is reversed, enabling the other end of the blink blind to be stopped against the scale 52 and then to be properly cut by the cutter unit 80. Thus, the desired size of blind is obtained.

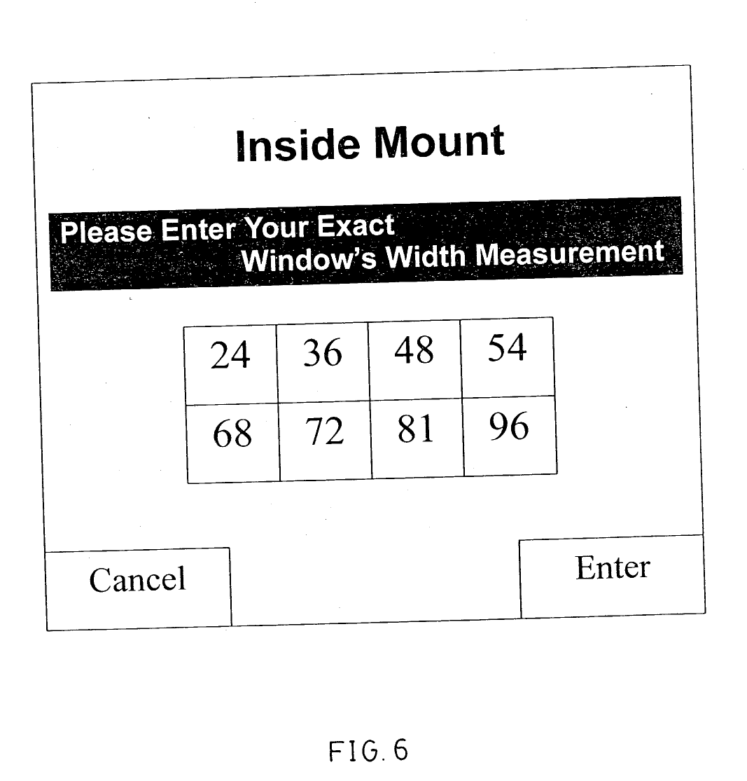

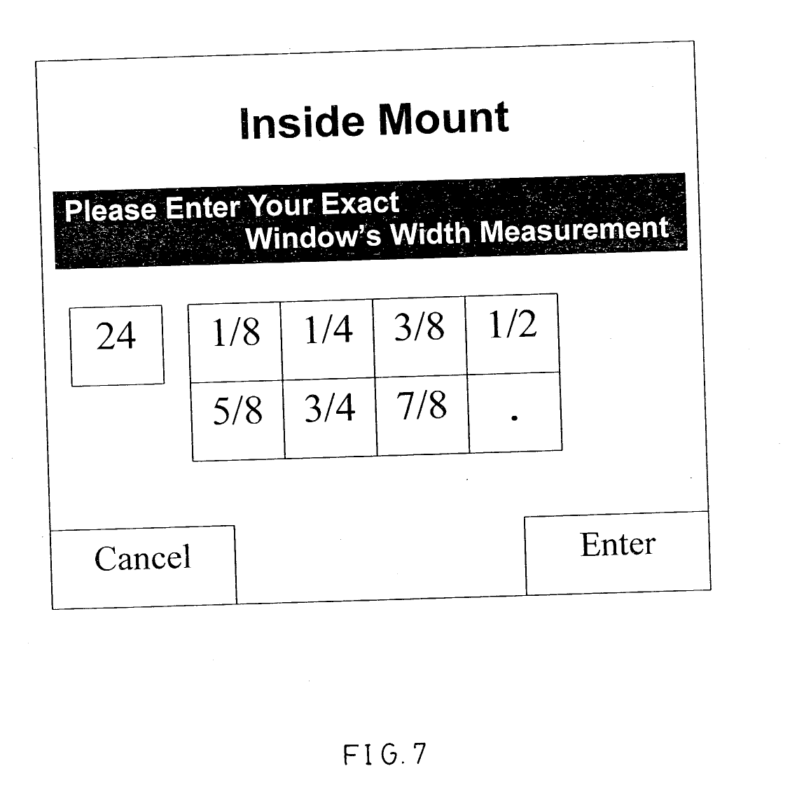

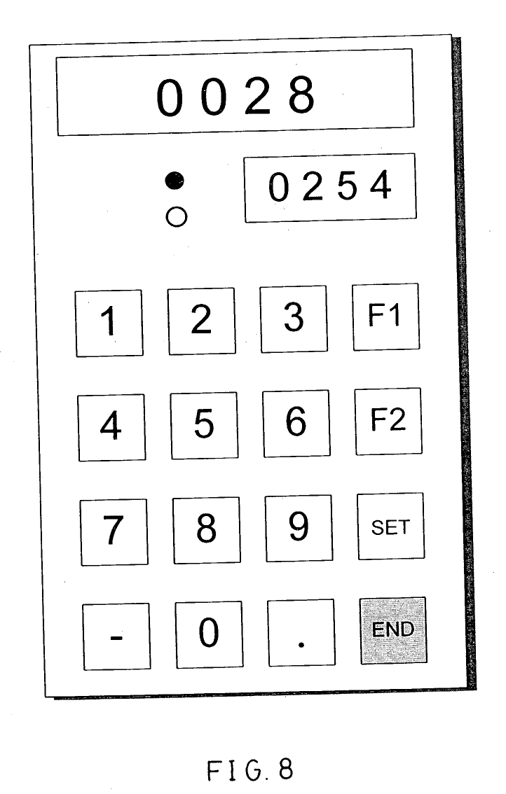

The action of inputting data into the control unit can be achieved by means of a human-machine interface or conventional input interface. When a human-machine interface is used, the operator achieves data input by selecting items from the prompt picture on the display screen (by the finger, a touch-pen, or a cursor control device). When selecting the cutting mode, options of DIE CUT/SAW CUT or corresponding pattern options are appeared on the display screen for selection. When selecting product type, options of PLASTICS/ALUMINUM, WOOD/BLIND HEADRAIL/BLIND BOTTOM RAIL are appeared on the display screen for selection. When selecting the mounting mode, options of INSIDE MOUNT/OUTSIDE MOUNT are appeared on the display screen for selection. When inputting the stock size, a series of measurement options in whole number (for example, 24, 26, 48 . . . as shown in FIG. 6) is appeared on the display screen for selection, and then corresponding measurement options in fraction (for example, ⅛, ¼, ⅜, ½, ⅝ . . . etc. as shown in FIG. 7) are appeared on the display screen for selection. Thereafter, when selecting stock size, a series of measurement options (for example, 21, 35, 49, . . . and etc.) is appeared on the display screen for selection. After data input, the control unit calculates the size to be cut off. When a conventional input interface is used, the conventional input interface includes a saw-cut selection button and a die-cut selection button for the selection of cutting mode, product type selection buttons for the selection of product type, inside mount and outside mount selection buttons of the selection of mounting type, and numerical entry buttons for window's width measurement input. As shown in FIG. 8, the operator directly inputs 254 for window's width 25+4/8 inches, and 28 for stock size 28 inches. After data input, the control unit calculates the size to be cut off, and drives the blind cutting size setting mechanism to move subject to the calculation result.

What is claimed is:

1. A blind cutting machine comprising:
a machine base;
at least one die cavity formed in said machine base for inserting a blank blind from the outside of said machine base to the inside of said machine base for cutting;
at least one cutter unit installed in said machine base for reciprocating feeding by a power drive across an inner side of said die cavity to cut off a blank blind inserted into said die cavity;
a blind cutting size setting mechanism installed in said machine base behind said cutter unit and movable between a start position and an end position for stopping a blank blind in said cavity in position for cutting; and
a control unit adapted to control the reciprocating feeding of said cutter unit and the setting of displacement of said blind cutting size setting mechanism between said start position and said end position, for enabling said blind cutting size setting mechanism to stop a blank blind in said cavity in position for cutting subject to a predetermined size to be cut off from said blank blind.

2. The blind cutting machine as defined in claim 1, wherein said control unit calculates the size to be cut off at each end of the blank blind to be cut subject to parameters inputted therein by means of a predetermined operation formula, and drives said blind cutting size setting mechanism to move to a predetermined position between said start position and said end position subject to the calculation result.

3. A blind cutting size setting mechanism for use in a blind cutting machine, said mechanism comprising:
a base frame;
a motor fixedly mounted on said base frame;
a locating frame including an open frame body fixedly fastened to said base frame, a transmission rod rotatably mounted to said open frame body and coupled to said motor for rotation upon operation of said motor, and at least one guide rod fastened to said open frame body; and
a positioning control unit adapted to move in said locating frame between a start position and an end position upon operation of said motor, said positioning control unit having a screw hole and at least one through hole respectively coupled to said transmission rod and said guide rod of said locating frame for enabling said positioning control unit to be moved along said guide rod between said start position and said end position upon rotary motion of said transmission screw rod.

4. The blind cutting size setting mechanism as defined in claim 3, wherein said motor comprises a signal feedback device adapted to transmit a signal indicative of the speed of said motor to an external interface for calculating to control the displacement of said positioning control unit to a predetermined location between said start position and said end position.

5. The blind cutting size setting mechanism as defined in claim 3, wherein said motor has a driving wheel fastened to an output shaft thereof; said transmission screw rod has a driven wheel fixedly mounted at an end thereof and coupled to said driving wheel of said motor through a transmission device for enabling said transmission rod to be rotated upon rotary motion of the output shaft of said motor.

6. The blind cutting size setting mechanism as defined in claim 3, wherein said transmission rod is a transmission screw rod threaded into the screw hole of said locating frame for driving said position control unit to move along said guide rod when rotated.

7. The blind cutting size setting mechanism as defined in claim 3, wherein said position control unit comprises a slide defining said screw hole and said at least one through hole, and a scale being an elongated rectangular plate member having an end fastened to a side of said slide.

8. The blind cutting size setting mechanism as defined in claim 7, wherein said base frame has a first micro switch and a second micro switch respectively disposed in said start position and said end position and adapted to stop said motor when touched; said slide has a protruded portion adapted to touch said first micro switch when moved to said start position, and to touch said second micro switch when moved to said end position.

9. A blind cutting size setting method for use in a blind cutting machine having a control unit, said method comprising the steps of
(a) inputting a predetermined cutting mode and product type into the control unit of the blind cutting machine;
(b) inputting window's width measurement and the size of the blank blind to be cut into the control unit of the blind cutting machine, enabling the control unit of the blind cutting machine to calculate the size to be cut off; and
(c) driving the control unit of the cutting machine to move a blind cutting size setting mechanism in the blind cutting machine to a predetermined position to stop the blank blind to be cut in position for cutting.

10. The blind cutting size setting method as defined in claim 9, wherein said step (a) includes a procedure of selecting either a die-cut cutting mode or a saw-cut cutting mode for the cutting mode.

11. The blind cutting size setting method as defined in claim 9, wherein said step (a) includes a procedure of selecting a material for the cutting mode.

12. The blind cutting size setting method as defined in claim 9, wherein said step (a) includes a procedure of selecting the headrail or bottom rail of the blind to be cut for the cutting mode.

13. The blind cutting size setting method as defined in claim 9, wherein said step (a) includes a procedure of selecting a blind mounting mode for the cutting mode.

14. The blind cutting size setting method as defined in claim 13, wherein a procedure of selecting either inside mount or outside mount for the blind mounting mode.

15. The blind cutting size setting method as defined in claim 14, wherein said step (b) includes a procedure of dividing the total size to be cut off by 2 to obtain the figure of the size to be cut off at each end of the blind when inside mount is selected.

16. The blind cutting size setting method as defined in claim 14, wherein said step (b) includes a procedure of dividing the total size to be cut off by 2 and then deducting ¼ inches from the quotient to obtain the figure of the size to be cut off at each end of the blind when inside mount is selected.

17. The blind cutting size setting method as defined in claim 9, wherein the control unit of the blind cutting machine comprises a human-machine interface for data entry.

18. The blind cutting size setting method as defined in claim 17, wherein said human-machine interface is adapted to display a wording or a logo selection menu on a display screen for enabling the user to input predetermined cutting mode and product type into the control unit of the blind cutting machine by clicking.

19. The blind cutting size setting method as defined in claim 9, wherein said control unit of the blind cutting machine comprises entry buttons for enabling the user to input a predetermined cutting mode and product type.
